(19) United States
(12) Patent Application Publication
(10) Pub. No.: US 2007/0121081 A1
(43) Pub. Date: May 31, 2007

(54) Projection lighting device

(76) Inventor: Hsiang-Chen Wu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/288,182

(22) Filed: Nov. 29, 2005

(51) Int. Cl. G03B 21/18

(52) U.S. Cl. 353/53

(57) ABSTRACT

A projection lighting device includes a light source unit having at least two frames each with a light emitting diode and a reflection member is connected to the light source unit. The reflection member includes at least two polyellipsoid surfaces so as to reflect the light beams from the light emitting diodes. The reflection member has two first flat surfaces in two ends thereof. A lens is connected to the light source unit and has two second flat surfaces in two ends thereof. The light source units can be arranged to be close to each other, the reflection member and the lens each have two flat surfaces such that the lighting device is compact in size.

### FIELD OF THE INVENTION

The present invention relates to a projection lighting device, and more particularly, to a compact vehicle lighting device using light emitting diodes.

### BACKGROUND OF THE INVENTION

A conventional projection lighting device 1 for vehicles is shown in FIGS. 1 and 2, and generally includes a light source unit 11 having a bulb 111 and a reflection member 112 wherein the bulb 111 is located at a first focus 2 of the reflection member 112 and the light beams from the bulb 111 are reflected by the reflection member 112 and focused at a second focus 3 and then go through the lens 12.

Thanks to the modern industry of semi-conductive chips, light emitting diodes are developed to a new level and able to provide high illumination with less energy consuming. The light emitting diodes are small and light in weight, have short response time and bear vibration. The light emitting diodes are used to be lighting device recently. As shown in FIG. 3, the projection lighting device 4 includes a light source unit 41 and a lens 42, wherein the light source unit 41 includes a board 411 and the light emitting diode 412 is connected to board 411, and a reflection member 41 is put on the designed position with respect to the board 411. However, multiple sets of the light source units 41 have to be used to provide a required quality light output for the vehicle lighting device. The multiple sets of the light source units 41 occupy too much space.

The present invention intends to provide a compact sized lighting device using light emitting diodes.

### SUMMARY OF THE INVENTION

The present invention relates to a projection lighting device that comprises a light source unit having a board having at least two light emitting diodes connected thereto. A reflection member is put on designed position with respect to the board and includes at least two curve inner peripheries and the light emitting diodes are located within the at least two curve inner peripheries correspondingly. Two first flat surfaces are defined in two ends of the reflection member. A lens is connected to the light source unit and has at least two continuous curve surfaces. The lens has at least two continuous curve top edges and at least two continuous curve bottom edges. Two second flat surfaces are defined in two ends of the lens.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a lens and a conventional head light device;

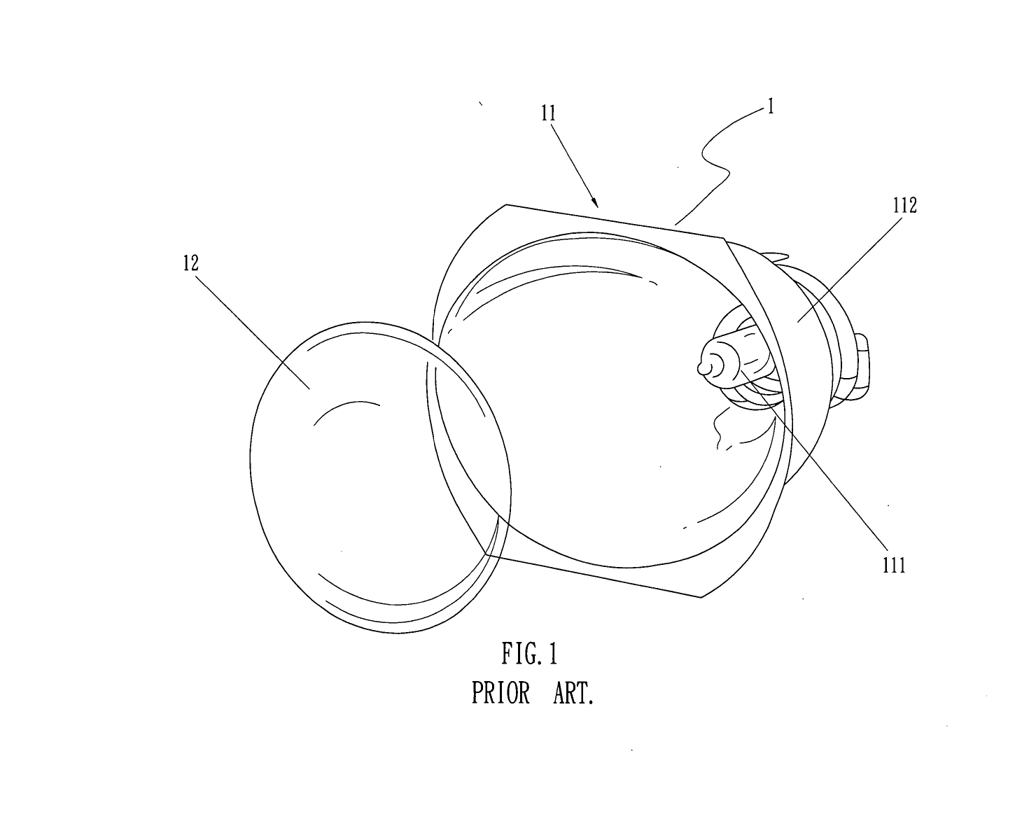

FIG. 2 shows the light beams are reflected by the reflection member of the conventional lighting device;

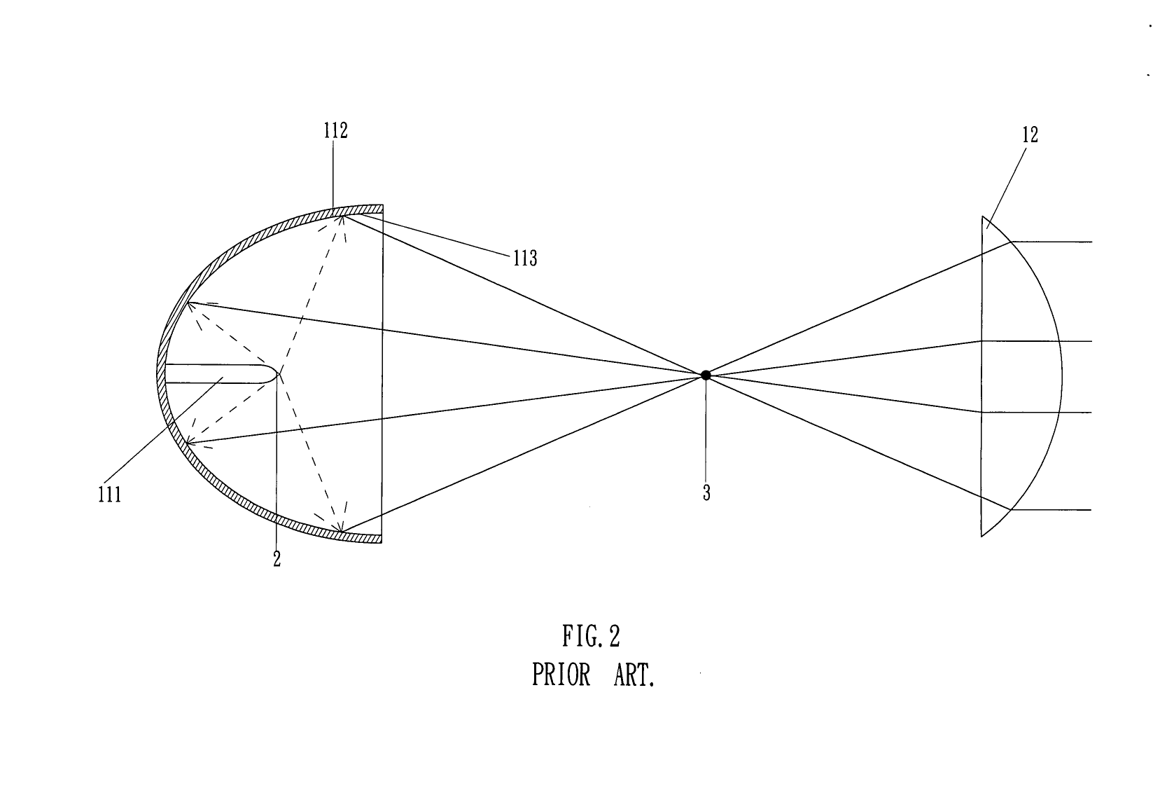

FIG. 3 shows a conventional head light device including multiple sets of light emitting diodes;

FIG. 4 is an exploded view to show the head light device of the present invention;

FIG. 5 is another exploded view to show the head light device of the present invention;

FIG. 6 shows the relationship between the illumination of a light emitting diode and angles that the light beams orientate;

FIG. 7 shows a vertical cross sectional view of the reflection member and the paths that the light beams are reflected;

FIG. 8 shows a horizontal cross sectional view of the reflection member and the paths that the light beams are reflected;

FIG. 9 shows a plate is located between the light source unit and the lens, and

FIG. 10 shows that a part of the light beam is blocked by the plate.

### DETAILED DESCRIPTION OF THE PREFERRED EMBODIMENT

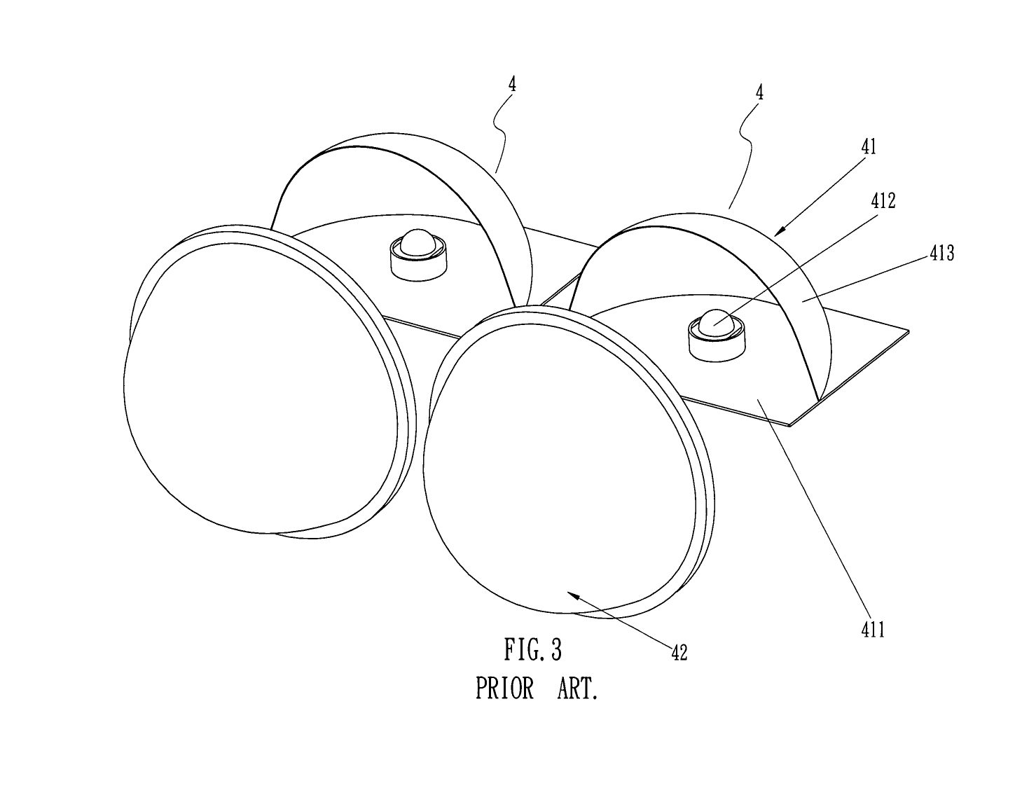

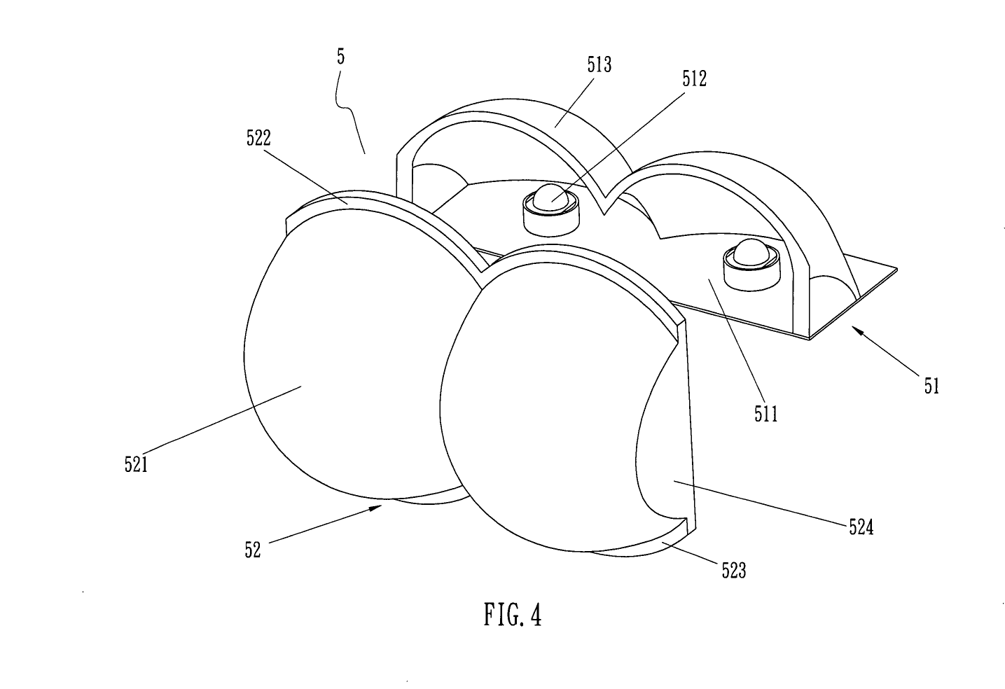

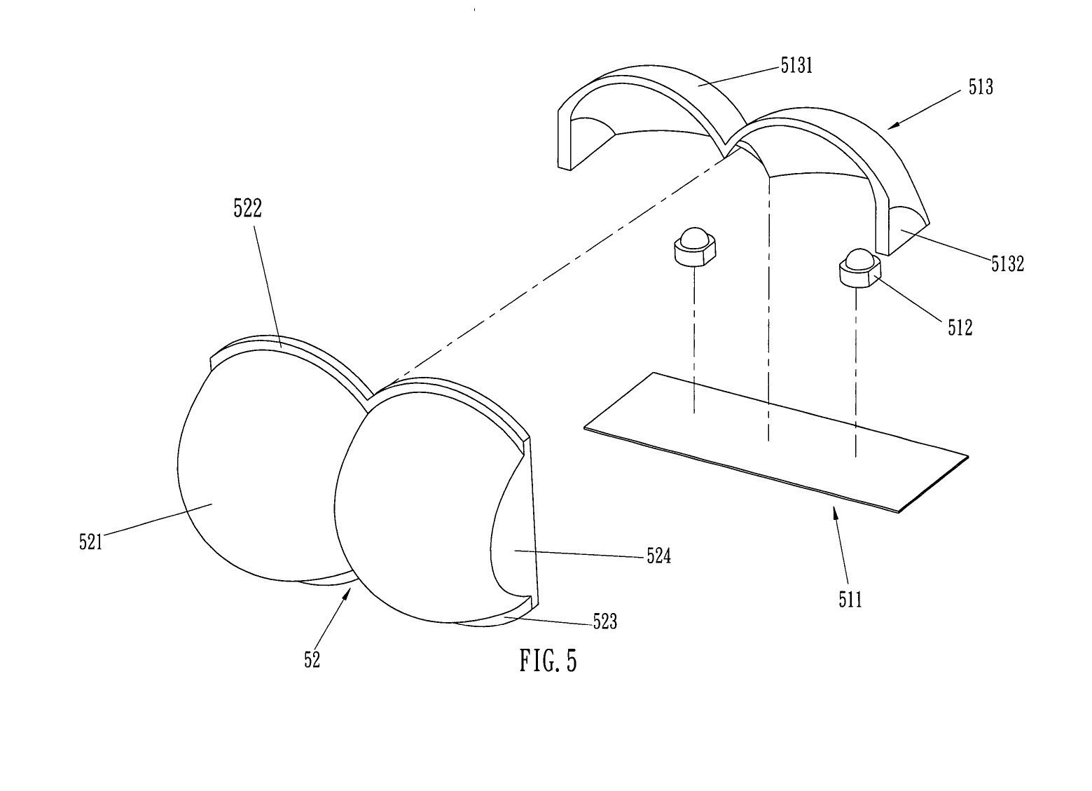

Referring to FIGS. 3 to 5, the projection head light device of the present invention comprises a light source unit 51 and a lens 52, wherein the light source unit 51 includes a board 511 and two light emitting diodes 512 connected thereto. A reflection member 513 is put on designed position with respect to the board 511 and includes two curve inner peripheries, the light emitting diodes 512 are located within the two curve inner peripheries correspondingly so that the light beams from the light emitting diodes 512 are reflected by the curve inner peripheries which will be defined specifically later. Two first flat surfaces 5132 are defined in two ends of the reflection member 5113.

The lens 52 is connected to the light source unit 51 and has two continuous curve surfaces 521. The lens 52 has continuous curve top edges 522 and at least two continuous curve bottom edges 523. Two second flat surfaces 524 are defined in two ends of the lens 52. The lens 52 can be an aspherical lens or a Fresnel lens.

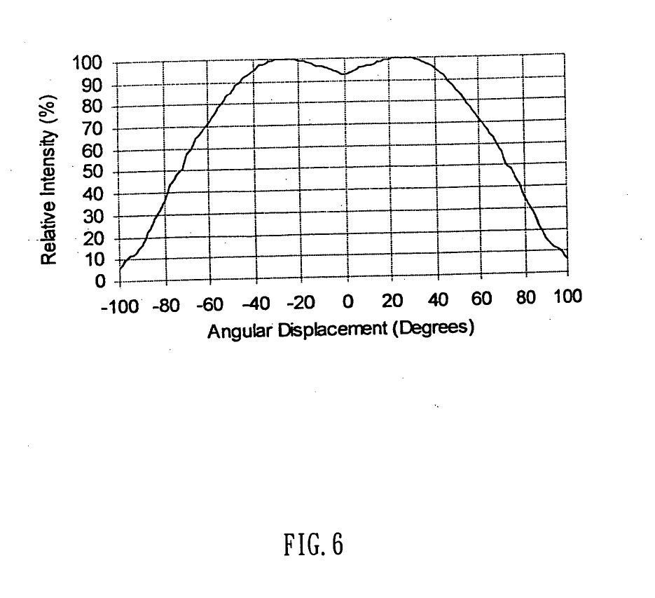

As shown in FIG. 6 which shows the relationship between the illumination of the light emitting diode 512 and angles that the light beams orientate. It is clear that the illumination of the light beams are high at the center of light output direction, for example, range from −40 degrees to +40 degrees, and the wider the angle is, the less illumination the beams is. In other words, the illumination on wider angles can be omitted when using the light emitting diodes 512 to a vehicle lighting device. In order to obtain a beam that meets regulations for vehicle lighting devices, the reflection member 513 includes different horizontal cross section and vertical cross section. The reflection surface 5131 comprises multiple focuses and this multiple-focus surface 5131 is polyellipsoid reflection surface.

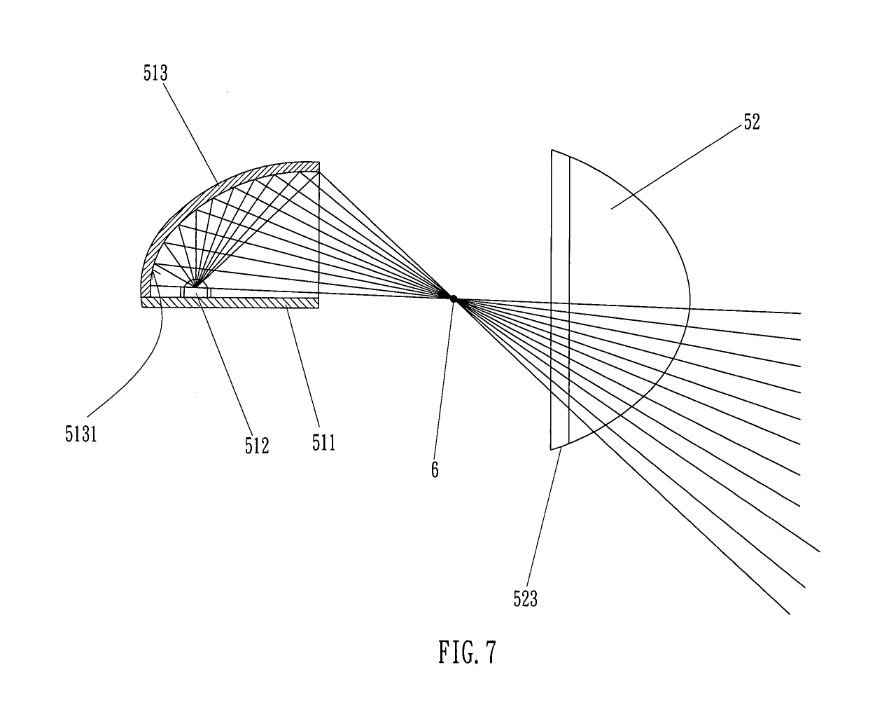

FIG. 7 shows the vertical cross section of the reflection member 513, the light beams from the light emitting diodes 512 are reflected by the polyellipsoid reflection surface and focused at the focus 6 of the lens 52. The light beams then go through the lens 52 or even through the top edges 522 and the bottom edges 523 of the lens 52.

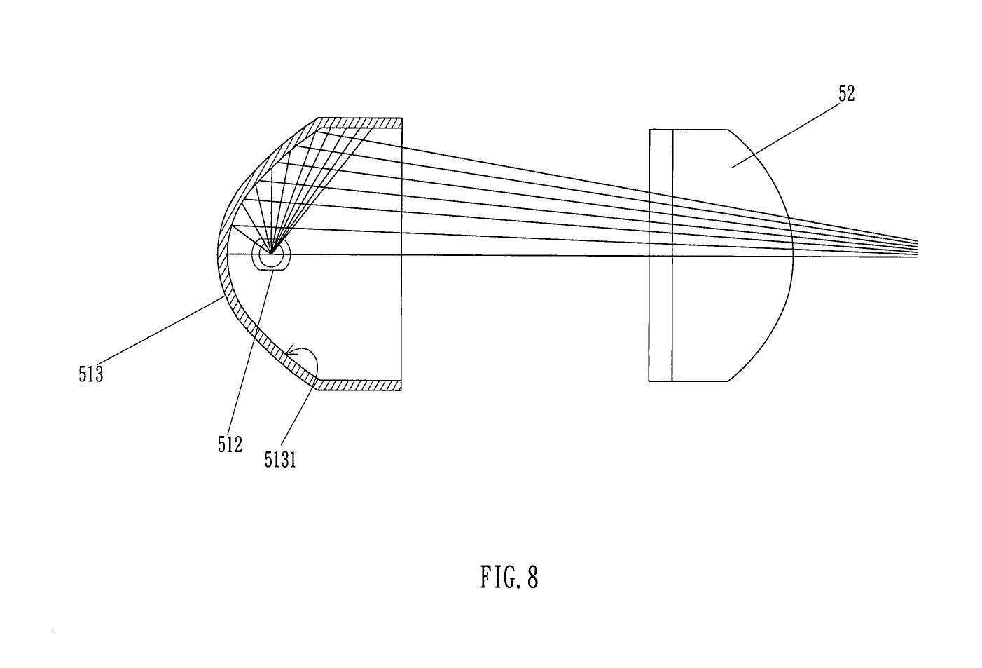

FIG. 8 shows the horizontal cross section of the reflection member 513, the light beams from the light emitting diodes 512 are reflected by the polyellipsoid reflection surface and focused at a remote distance via the lens 52. The light beams reflected by the vertical cross section and the horizontal cross section are combined to form a wide and flat range of light beam which is perfect for the head light device of vehicles.

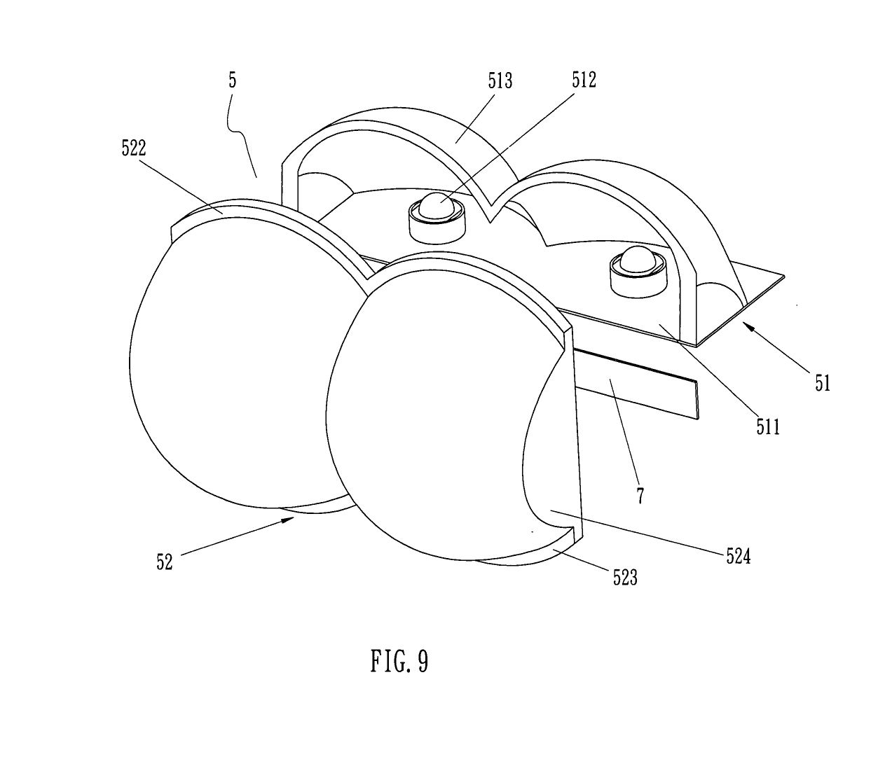

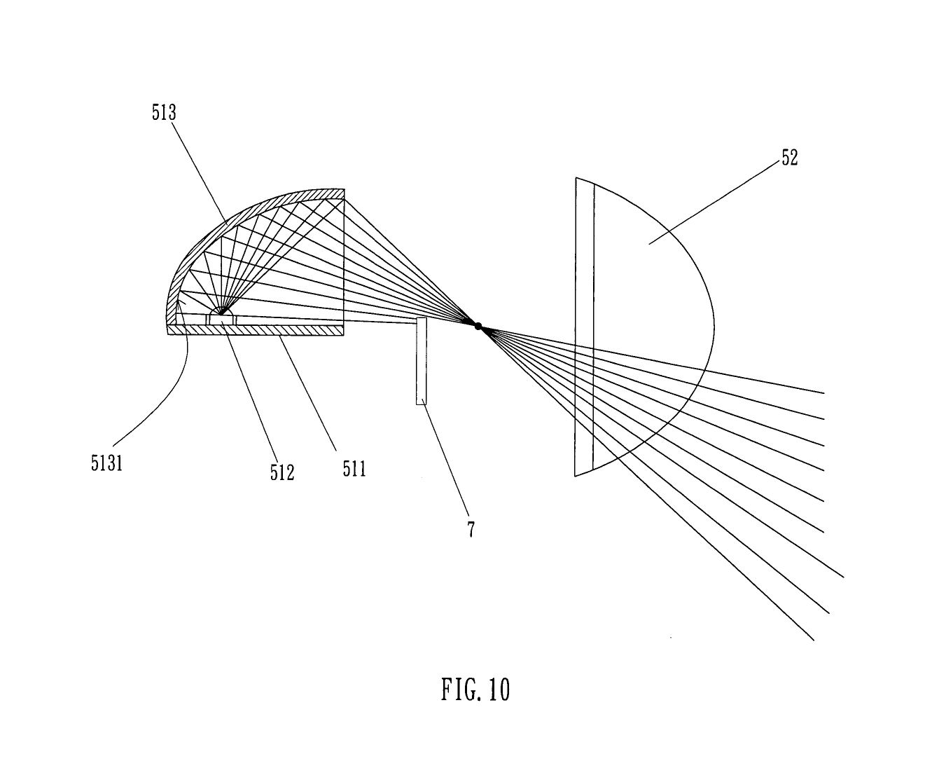

FIGS. 9 and 10 show another embodiment of the present invention wherein there is a plate 7 located between the light source unit 51 and the lens 52, wherein the plate 7 can block a part of the light beams so as to form the high beam and short beam when using for a vehicle head light device.

The lens 52 and the reflection member 513 each have two flat surfaces 5132, 524 so that the area that the lighting device occupies is reduced and more lenses 52 can be arranged in a limited area and which means more light emitting diodes 512 are installed in the head light device. Because the illumination at wider angles are weak so that the narrower lenses 52 and reflection members 513 do not affect the illumination of the lighting device.

While we have shown and described the embodiment in accordance with the present invention, it should be clear to those skilled in the art that further embodiments may be made without departing from the scope of the present invention.

What is claimed is:

1. A projection lighting device comprising:
a light source unit having a board and at least two light emitting diodes connected thereto, a reflection member put on designed position with respect to the board and including at least two curve inner peripheries, the light emitting diodes located within the at least two curve inner peripheries correspondingly, two first flat surfaces defined in two ends of the reflection member, and
a lens connected to the light source unit and having at least two continuous curve surfaces, the lens having at least two continuous curve top edges and at least two continuous curve bottom edges, two second flat surfaces defined in two ends of the lens.

2. The device as claimed in claim 1, wherein the lens is an aspherical lens.

3. The device as claimed in claim 2, wherein the lens is a Fresnel lens.

4. The device as claimed in claim 1 further comprising a plate located between the light source unit and the lens.
